(19) United States
(12) Patent Application Publication
(10) Pub. No.: US 2026/0310138 A1
(43) Pub. Date: Oct. 8, 2026

(54) VISUAL COUNTDOWN TASK TIMER DEVICE

(71) Applicant: James Baylis, Highland Park, NJ (US)

(72) Inventor: James Baylis, Highland Park, NJ (US)

(21) Appl. No.: 19/446,138

(22) Filed: Jan. 12, 2026

Related U.S. Application Data
(60) Provisional application No. 63/774,510, filed on Mar. 19, 2025.

(51) Int. Cl. G04F 1/00

(52) U.S. Cl. CPC G04F 1/005

(57) ABSTRACT

A visual countdown task timer device includes a housing and an electronic timer integrated into the housing. The electronic timer is actuated to begin counting down the duration of time when the button is depressed an initial time. The duration of time is incrementally increased each time the action control is actuated subsequent to being actuated the initial time. A plurality of non-numeric visual indicators is coupled to the housing. A respective number of non-numeric visual indicators is actuated which corresponds to a number of times the action control is actuated to visually communicate the selected duration of time to the user. Each of the non-numeric visual indicators is de-actuated in sequence according to the selected duration of time and the non-numeric visual indicators are radially distributed on the housing.

### CROSS-REFERENCE TO RELATED APPLICATIONS

I hereby claim the benefit under 35 U.S.C. Section 119(e) of U.S. Provisional application 63/774,510 filed Jan. 13, 2025.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to task timer devices and more particularly pertains to a new task timer device for counting down a duration of time. The device includes a housing and an electronic timer integrated into the housing. The device includes a button integrated into the housing which actuates the electronic timer when the button is depressed an initial time and which adjusts the duration of time according to a number of times the button is subsequently depressed. The device includes a plurality of non-numeric visual indicators coupled to the housing and a respective number of the non-numeric visual indicators is actuated according to the duration of time that is selected with the button. Furthermore, the respective number of non-numeric visual indicators are de-actuated in sequence as the duration of time is counted down by the electronic timer.

### (2) Description of Related Art Including Information Disclosed Under 37 CFR 1.97 and 1.98

The prior art relates to task timer devices including: a variety of personal electronic timers that each at least includes a housing and an electronic timer integrated into the housing and a display coupled to the housing which displays numbers to communicate a duration of time being counted down by the electronic timer; a proportional count down timer which includes a housing and an electronic timer integrated into the housing and a display coupled to the housing which displays numbers to communicate a duration of time being counted down by the electronic timer and plurality of non-numeric visual indicators arranged in a row on the housing which are actuated correlating to the duration of time being counted down by the electronic timer. In no instance does the prior art disclose a visual countdown task timer device that includes a housing and an electronic timer integrated into the housing and a button movably integrated into the housing which actuates the electronic timer and a plurality of non-numeric visual indicators which are radially distributed on the housing and which are sequentially de-actuated to visually communicate the remaining duration of time being counted down by the electronic timer.

### BRIEF SUMMARY OF THE INVENTION

An embodiment of the disclosure meets the needs presented above by generally comprising a housing and an electronic timer integrated into the housing. The electronic timer is actuated to begin counting down the duration of time when an action control, such as a button, is actuated an initial time. The duration of time is incrementally increased each time the button is depressed subsequent to being depressed the initial time. A plurality of non-numeric visual indicators is coupled to the housing to emit light outwardly from the housing. A respective number of non-numeric visual indicators is actuated which corresponds to a number of times the button is depressed to visually communicate the selected duration of time to the user. Each of the non-numeric visual indicators is de-actuated in sequence according to the selected duration of time and the non-numeric visual indicators are radially distributed on the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a visual countdown task timer device according to an embodiment of the disclosure.

FIG. 2 is a front phantom view of an embodiment of the disclosure.

FIG. 3 is a back phantom view of an embodiment of the disclosure.

FIG. 4 is a back perspective view of an embodiment of the disclosure.

FIG. 5 is a perspective in-use view of an embodiment of the disclosure.

FIG. 6 is a schematic view of an embodiment of the disclosure.

### DETAILED DESCRIPTION OF THE INVENTION

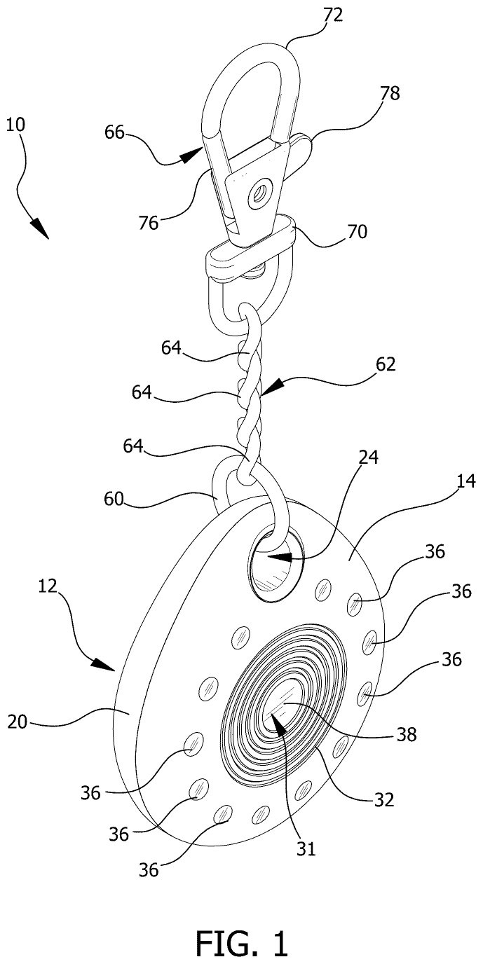

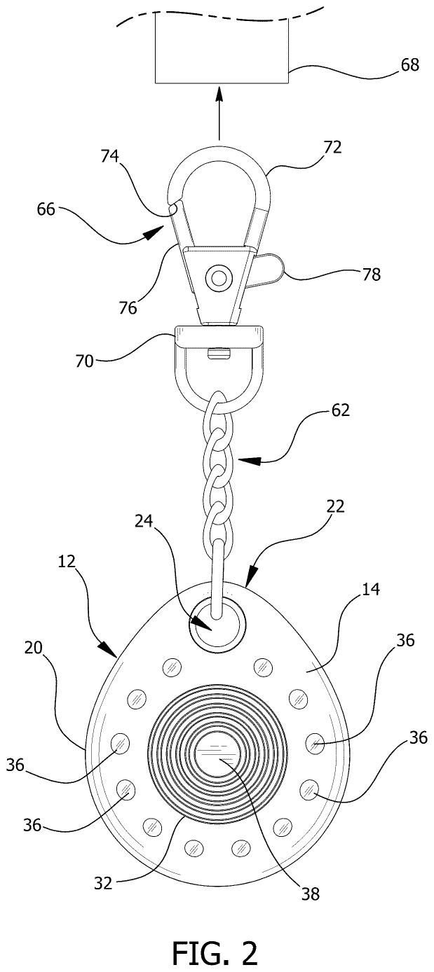

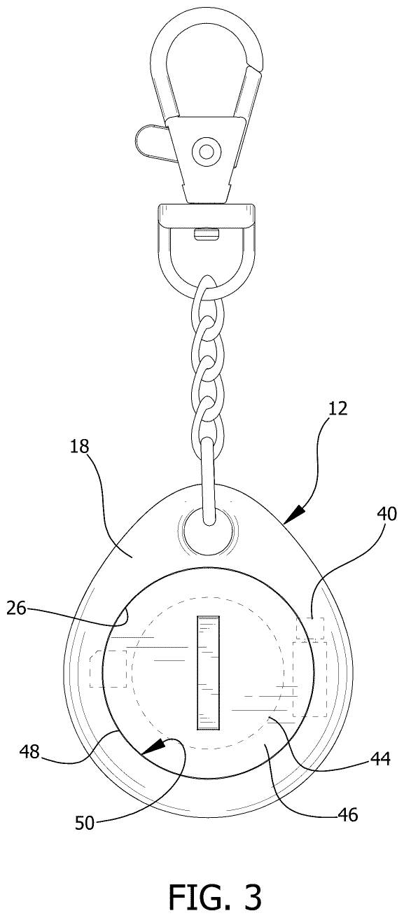

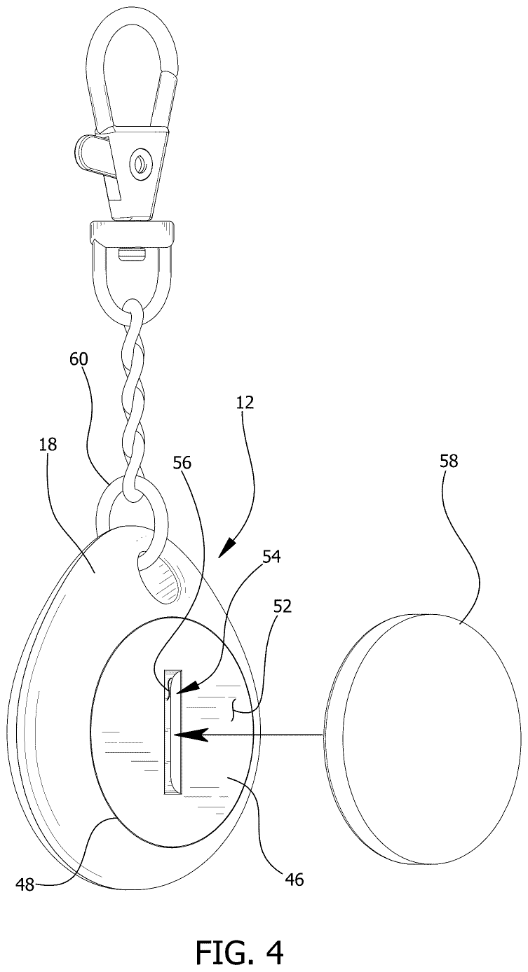

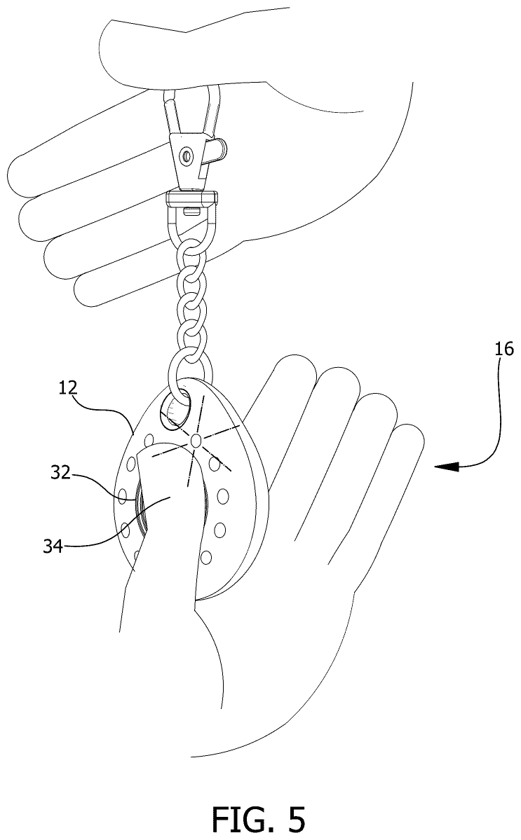

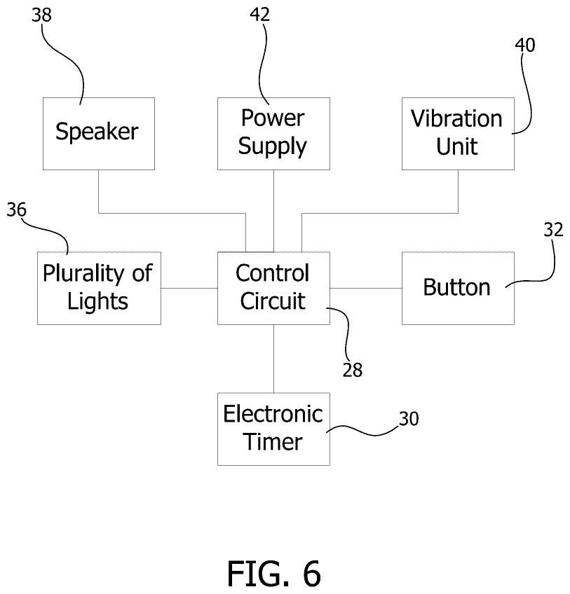

With reference now to the drawings, and in particular to FIGS. 1 through 6 thereof, a new task timer device embodying the principles and concepts of an embodiment of the disclosure and generally designated by the reference numeral 10 will be described.

As best illustrated in FIGS. 1 through 6, the visual countdown task timer device 10 generally comprises a housing 12 that has a front face 14 which is visible to a user 16. As is shown in the figures, the housing 12 may have a back face 18 and a perimeter edge 20 extending between the front face 14 and the back face 18. Additionally, the perimeter edge 20 may be continuously arcuate about a center of the housing 12 such that the housing 12 has a rounded shape to inhibit snagging. Furthermore, the housing 12 may be elongated along a lengthwise axis such that the housing 12 has an ovoid shape to be visually appealing to the user 16. The perimeter edge 20 may has an apex 22 which is aligned with the longitudinal axis such that the housing 12 may have an egg shape. Furthermore, the housing may be structured in any conceivable geometric shape that is suitable for holding or for being stored in a pocket of clothing, for example. The user 16 may be a neurodivergent person, such as a person diagnosed with Attention Deficit/Hyperactivity Disorder for example, or other individual who struggles with remaining on task.

The housing 12 has a hole 24 extending through the front face 14 and the back face 18 of the housing 12. The hole 24 is aligned with the apex 22 of the perimeter edge 20. In addition, the housing 12 has a battery well 26 which is recessed into the back face 18. A control circuit 28 is integrated into the housing 12 and the control circuit 28 receives an alert input.

An electronic timer 30 is integrated into the housing 12 and the electronic timer 30 is in electrical communication with the control circuit 28. The electronic timer 30 is actuatable to countdown a duration of time and the duration of time is adjustable in pre-determined increments of time. Furthermore, the control circuit 28 receives the alert input when the electronic timer 30 finishes counting down the duration of time. The duration of time may be adjustable to range between approximately five minutes and sixty minutes. In addition, the pre-determined increments of time may range between approximately fifteen seconds and five minutes, the duration of which is determined during the manufacturing process of the electronic timer 30.

An action control, such as a button 32, is movably integrated into the housing 12 such that the button 32 can be depressed by the user 16 and the button 32 is in electrical communication with the control circuit 28. The electronic timer 30 is actuated to begin counting down the duration of time when the button 32 is depressed an initial time such the user 16 can actuate the electronic timer 30. Additionally, a default duration of time is selected when the button 32 is depressed the initial time. The default duration of time may be adjusted such that a desired initial duration of time is selected by the initial actuation of the button 32. The duration of time is incrementally increased by the pre-determined increments of time each time the button 32 is depressed subsequent to being depressed the initial time. In this manner the user 16 can increase the duration of time according to the user's 16 preference. The button 32 is positioned on the front face 14 of the housing 12 such that the button 32 is accessible to the user 16. Furthermore, the button 32 is centrally located on the front face 14 of the housing 12 such that the button 32 is aligned with a thumb 34 of the user 16 when the user 16 grips the housing 12. A switch, or other means of electronic switching, may be provided in lieu of the button 32 for controlling the electronic timer 30.

A plurality of non-numeric visual indicators 36 is each coupled to the housing 12 and may emit light outwardly from the housing 12. Each light 36 of the plurality of non-numeric visual indicators 36 is in electrical communication with the control circuit 28. A respective number of the plurality of non-numeric visual indicators 36 is actuated which corresponds to a number of times the button 32 is depressed subsequent to the button 32 being depressed the initial time. Consequently the plurality of non-numeric visual indicators 36 can visually communicate the selected duration of time to the user 16. Each of the respective number of non-numeric visual indicators 36 is de-actuated in sequence according to the selected duration of time to visually communicate to the user 16 the increments of time remaining in the selected duration of time.

The plurality of non-numeric visual indicators 36 is positioned on the front face 14 of the housing 12 such that the plurality of non-numeric visual indicators 36 are visible to the user 16. Additionally, the non-numeric visual indicators 36 are evenly spaced apart from each other and are distributed around a full circumference of the button 32 to enhance the ornamental appearance of the selected duration of time to the user 16. Each light 36 of the plurality of non-numeric visual indicators 36 may comprise a light emitting diode or other type of electronic light emitter.

A speaker 38 is integrated into the housing 12 to emit an audible alert from the housing 12 and the speaker 38 is in electrical communication with the control circuit 28. The control circuit 28 receives the alert input when the electronic timer 30 finishes counting down the duration of time. Furthermore, the speaker 38 is actuated when the control circuit 28 receives the alert input to audibly communicate to the user 16 that the duration of time has elapsed. The speaker 38 may be integrated into the button 32 or the speaker 38 may be located on the front face 14 of the housing 12 or the speaker 38 may be located at any suitable position on the housing 12 for emitting audible sound.

A vibration unit 40 is integrated into the housing 12 and the vibration unit 40 is in mechanical communication with the housing 12. Additionally, the vibration unit 40 vibrates the housing 12 when the vibration unit 40 is actuated to produce haptic feedback for the user 16. The vibration unit 40 is in electrical communication with the control circuit 28 and the vibration unit 40 is actuated when the control circuit 28 receives the alert input. Furthermore, the vibration unit 40 physically communicates to the user 16 that the duration of time has elapsed. The vibration unit 40 may comprise an electromechanical vibration device of any conventional design, including but not being limited to an electric motor and a cam that is rotated by the electric motor. Additionally, the speaker 38 and the vibration unit 40 may be actuated independently of each other or in unison, depending on the user's 16 preference or the speaker 38 and the vibration unit 40 may be inhibited from being actuated.

A power supply 42 is removably positioned in the housing 12 and the power supply 42 is in electrical communication with the control circuit 28. The power supply 42 comprises at least one battery 44 which is removably positionable in the battery well 26 in the back face 18 of the housing 12. A battery cover 46 is provided which has an outer edge 48 and the battery well 26 in the back face 18 of the housing 12 has a bounding edge 50. The outer edge 48 removably engages the bounding edge 50 of the battery well 26 to retain the at least one battery 44 in the battery well 26.

The battery cover 46 has an exposed surface 52 and the exposed surface 52 lies on a plane which is coplanar with the back face 18 of the housing 12 when the battery cover 46 is positioned in the battery well 26 to inhibit snagging. A slot 54 is recessed into the exposed surface 52 and the slot 54 has a lower bounding surface 56. Furthermore, the lower bounding surface 56 is concavely arcuate with respect to the exposed surface 52 of the battery cover 46 to insertably receive a coin 58 for removing the battery cover 46 from the housing 12.

An annular ring 60 extends through the hole 24 in the housing 12 and a chain 62 is coupled to the housing 12. Furthermore, the chain 62 comprises a plurality of links 64 and a respective link 64 of the chain 62 extends through the annular ring 60. A clamp 66 is coupled to the chain 62 which can be manipulated by the user 16. The clamp 66 is urgeable into an open position be removably coupled to a support 68, such as clothing of the user 16, for example. The clamp 66 is biased into a closed position to releasably engage the support 68.

The clamp 66 includes a pivot 70 which extends through a respective link of the chain 62 and the pivot 70 is distally located with respect to the housing 12. The clamp 66 includes a first jaw 72 which is rotatably coupled to the pivot 70. The first jaw 72 is rotatable about a lengthwise axis of the chain 62 such that the clamp 66 enables the housing 12 to rotate on the support to which the clamp 66 is removably coupled. The first jaw 72 has a distal end 74 with respect to the pivot 70. Furthermore, the first jaw 72 is curved such that the distal end 74 is directed toward the pivot 70 such that the first jaw 72 can be suspended on the support 68.

The clamp 66 includes a second jaw 76 which is pivotally coupled to the pivot 70. The second jaw 76 is biased into a first position having the second jaw 76 extending between the pivot 70 and the distal end 74 of the first jaw 72 to retain the first jaw 72 on the support 68. In addition, the second jaw 76 is urgeable into a second position having the second jaw 76 being displaced from the distal end 74 of the first jaw 72. Consequently the second jaw 76 enables the first jaw 72 to be removable from the support 68. The clamp 66 includes a finger 78 extending laterally away from the second jaw 76 which can be depressed by the user 16. The second jaw 76 is urged into the second position when the finger 78 is depressed to enable the user 16 to release the first jaw 72 from the support 68.

In use, the user 16 depresses the button 32 the initial time to actuate the electronic timer 30 to begin counting down the duration of time. Additionally, the user 16 depresses the button 32 a chosen number of times subsequent to being initially depressed to increase the duration of time being counted down by the pre-determined increments of time for the electronic timer 30. Consequently the number of non-numeric visual indicators 36 that is actuated corresponds to the number of pre-determined increments of time chosen by the user 16. The number of non-numeric visual indicators 36 which are actuated are subsequently de-actuated in sequence according to the selected duration of time chosen by the user 16. In this manner that user 16 can visually identify the duration of time that remains in the duration of time being counted down by the electronic timer 30. The speaker 38 and the vibration unit 40 are each actuated when the electronic timer 30 completes counting down the duration of time chosen by the user 16 to alert the user 16 that the duration of time has elapsed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A visual countdown task timer device comprising:
a housing;
a control circuit being integrated into said housing, said control circuit receiving an alert input;
an electronic timer being integrated into said housing, said electronic timer being in electrical communication with said control circuit, said electronic timer being actuatable to countdown a duration of time, said duration of time being adjustable in pre-determined increments of time, said control circuit receiving said alert input when said electronic timer finishes counting down said duration of time;
an action control being integrated into said housing wherein said action control is configured to be actuated by the user, said action control being in electrical communication with said control circuit, said electronic timer being actuated to begin counting down said duration of time when said action control is actuated an initial time wherein said action control is configured to have the user actuate said electronic timer, a default duration of time being selected when said action control is actuated said initial time, said duration of time being incrementally increased by said pre-determined increments of time each time said action control is depressed subsequent to being actuated said initial time wherein said action control is configured to have the user increase said duration of time according to the user's preference; and
a plurality of non-numeric visual indicators, each non-numeric visual indicator of said plurality of non-numeric visual indicators being in electrical communication with said control circuit, a respective number of said plurality of non-numeric visual indicators being actuated which corresponds to a number of times said action control is actuated subsequent to said action control being actuated said initial time wherein said plurality of non-numeric visual indicators is configured to visually communicate the selected duration of time to the user, each of said respective number of non-numeric visual indicators being de-actuated in sequence according to said selected duration of time wherein said respective number of non-numeric visual indicators is configured to visually communicate to the user the increments of time remaining in said selected duration of time.

2. The device according to claim 1, further comprising:
a chain being coupled to said housing; and
a clamp being coupled to said chain wherein said clamp is configured to be manipulated by the user;
said clamp being urgeable into an open position wherein said clamp is configured to be removably coupled to a support; and
said clamp being biased into a closed position wherein said clamp is configured to releasably engage the support.

3. The visual countdown task timer device according to claim 1, further comprising:
said housing having a front face wherein said front face is configured to be visible to a user;
said housing having a back face and a perimeter edge extending between said front face and said back face;
said perimeter edge being continuously arcuate about a center of said housing such that said housing has a rounded shape wherein said perimeter edge is configured to inhibit snagging;
said housing being elongated along a lengthwise axis such that said housing has an ovoid shape wherein said housing is configured to be visually appealing to the user;
said perimeter edge having an apex being aligned with said longitudinal axis such that said housing has an egg shape;
said housing having a hole extending through said front face and said back face of said housing; and
said hole being aligned with said apex of said perimeter edge.

4. The visual countdown task timer device according to claim 1, further comprising:
said housing having a front face;
said action control being positioned on said front face of said housing wherein said action control is configured to be accessible to the user; and
said action control being centrally located on said front face of said housing wherein said action control is configured to be aligned with a thumb of the user when the user grips said housing.

5. The visual countdown task timer device according to claim 4, further comprising:
said plurality of non-numeric visual indicators being positioned on said front face of said housing wherein said plurality of non-numeric visual indicators is configured to be visible to the user; and
said plurality of non-numeric visual indicators being evenly spaced apart from each other and being distributed around a full circumference of said action control wherein said plurality of non-numeric visual indicators is configured to enhance the ornamental appearance of said selected duration of time to the user.

6. The visual countdown task timer device according to claim 1, further comprising:
a speaker being integrated into said housing wherein said speaker is configured to emit an audible alert from said housing;
said speaker being in electrical communication with said control circuit;
said control circuit receiving said alert input when said electronic timer finishes counting down said duration of time; and
said speaker being actuated when said control circuit receives said alert input wherein said speaker is configured to audibly communicate to the user that said duration of time has elapsed.

7. The visual countdown task timer device according to claim 1, further comprising:
a vibration unit being integrated into said housing;
said vibration unit being in mechanical communication with said housing;
said vibration unit vibrating said housing when said vibration unit is actuated wherein said vibration unit is configured to produce haptic feedback for the user;
said vibration unit being in electrical communication with said control circuit; and
said vibration unit being actuated when said control circuit receives said alert input wherein said vibration unit is configured to physically communicate to the user that said duration of time has elapsed.

8. The visual countdown task timer device according to claim 1, further comprising:
said housing having a back face;
said housing having a battery well being recessed into said back face;
a power supply being removably positioned in said housing;
said power supply being in electrical communication with said control circuit;
said power supply comprising at least one battery;
said at least one battery being removably positionable in said battery well in said back face of said housing;
a battery cover having an outer edge;
said battery well in said back face of said housing having a bounding edge;
said outer edge of said battery cover removably engaging said bounding edge of said battery well to retain said at least one battery in said battery well;
said battery cover having an exposed surface;
said exposed surface lying on a plane being coplanar with said back face of said housing when said battery cover is positioned in said battery well wherein said exposed face is configured to inhibit snagging;
said battery cover having a slot being recessed into said exposed surface;
said slot having a lower bounding surface; and
said lower bounding surface being concavely arcuate with respect to said exposed surface of said battery cover wherein said slot is configured to insertably receive a coin for removing said battery cover from said housing.

9. The visual countdown task timer device according to claim 1, further comprising:
said housing having a front face and a back face;
said housing having a hole extending through said front face and said back face;
an annular ring extending through said hole in said housing;
said chain comprising a plurality of links; and
a respective link of said chain extending through said annular ring.

10. The visual countdown task timer device according to claim 2, further comprising:
said clamp comprising:
a pivot extending through a respective link of said chain, said pivot being distally located with respect to said housing;
a first jaw being rotatably coupled to said pivot, said first jaw being rotatable about a lengthwise axis of said chain wherein said clamp is configured to have said housing rotate on the support to which said clamp is removably coupled, said first jaw having a distal end with respect to said pivot, said first jaw being curved such that said distal end is directed toward said pivot wherein said first jaw is configured to be suspended on the support;
a second jaw being pivotally coupled to said pivot, said second jaw being biased into a first position having said second jaw extending between said pivot and said distal end of said first jaw wherein said second jaw is configured to retain said first jaw on the support, said second jaw being urgeable into a second position having said second jaw being displaced from said distal end of said first jaw wherein said second jaw is configured to have said first jaw be removable from the support; and
a finger extending laterally away from said second jaw wherein said finger is configured to be depressed by the user, said second jaw being urged into said second position when said finger is depressed wherein said finger is configured to have the user release said first jaw from the support.

11. The device according to claim 1, further comprising said plurality of non-numeric visual indicators being radially distributed on said housing wherein said plurality of non-numeric visual indicators is configured to have the ornamental appearance of a clock.

12. The device according to claim 1, wherein each non-numeric visual indicator is a light, each light of said plurality of non-numeric visual indicators being coupled to said housing wherein each light of said plurality of non-numeric visual indicators is configured to emit light outwardly from said housing, each light of said plurality of non-numeric visual indicators being in electrical communication with said control circuit.

13. The device according to claim 1, wherein said action control is a button actuated by depressing said button.

14. A visual countdown task timer device comprising:
a housing having a front face wherein said front face is configured to be visible to a user, said housing having a back face and a perimeter edge extending between said front face and said back face, said perimeter edge being continuously arcuate about a center of said housing such that said housing has a rounded shape wherein said perimeter edge is configured to inhibit snagging, said housing being elongated along a lengthwise axis such that said housing has an ovoid shape wherein said housing is configured to be visually appealing to the user, said perimeter edge having an apex being aligned with said longitudinal axis such that said housing has an egg shape, said housing having a hole extending through said front face and said back face of said housing, said hole being aligned with said apex of said perimeter edge, said housing having a battery well being recessed into said back face;
a control circuit being integrated into said housing, said control circuit receiving an alert input;
an electronic timer being integrated into said housing, said electronic timer being in electrical communication with said control circuit, said electronic timer being actuatable to countdown a duration of time, said duration of time being adjustable in pre-determined increments of time, said control circuit receiving said alert input when said electronic timer finishes counting down said duration of time;
a button being movably integrated into said housing wherein said button is configured to be depressed by the user, said button being in electrical communication with said control circuit, said electronic timer being actuated to begin counting down said duration of time when said button is depressed an initial time wherein said button is configured to have the user actuate said electronic timer, a default duration of time being selected when said button is depressed said initial time, said duration of time being incrementally increased by said pre-determined increments of time each time said button is depressed subsequent to being depressed said initial time wherein said button is configured to have the user increase said duration of time according to the user's preference, said button being positioned on said front face of said housing wherein said button is configured to be accessible to the user, said button being centrally located on said front face of said housing wherein said button is configured to be aligned with a thumb of the user when the user grips said housing;
a plurality of non-numeric visual indicators, each light of said plurality of non-numeric visual indicators being coupled to said housing wherein each light of said plurality of non-numeric visual indicators is configured to emit light outwardly from said housing, each light of said plurality of non-numeric visual indicators being in electrical communication with said control circuit, a respective number of said plurality of non-numeric visual indicators being actuated which corresponds to a number of times said button is depressed subsequent to said button being depressed said initial time wherein said plurality of non-numeric visual indicators is configured to visually communicate the selected duration of time to the user, each of said respective number of non-numeric visual indicators being de-actuated in sequence according to said selected duration of time wherein said respective number of non-numeric visual indicators is configured to visually communicate to the user the increments of time remaining in said selected duration of time, said plurality of non-numeric visual indicators being positioned on said front face of said housing wherein said plurality of non-numeric visual indicators is configured to be visible to the user, said plurality of non-numeric visual indicators being evenly spaced apart from each other and being distributed around a full circumference of said button wherein said plurality of non-numeric visual indicators is configured to enhance the ornamental appearance of said selected duration of time to the user;
a speaker being integrated into said housing wherein said speaker is configured to emit an audible alert from said housing, said speaker being in electrical communication with said control circuit, said control circuit receiving said alert input when said electronic timer finishes counting down said duration of time, said speaker being actuated when said control circuit receives said alert input wherein said speaker is configured to audibly communicate to the user that said duration of time has elapsed;
a vibration unit being integrated into said housing, said vibration unit being in mechanical communication with said housing, said vibration unit vibrating said housing when said vibration unit is actuated wherein said vibration unit is configured to produce haptic feedback for the user, said vibration unit being in electrical communication with said control circuit, said vibration unit being actuated when said control circuit receives said alert input wherein said vibration unit is configured to physically communicate to the user that said duration of time has elapsed;
a power supply being removably positioned in said housing, said power supply being in electrical communication with said control circuit, said power supply comprising at least one battery, said at least one battery being removably positionable in said battery well in said back face of said housing;
a battery cover having an outer edge, said battery well in said back face of said housing having a bounding edge, said outer edge removably engaging said bounding edge of said battery well to retain said at least one battery in said battery well, said battery cover having an exposed surface, said exposed surface lying on a plane being coplanar with said back face of said housing when said battery cover is positioned in said battery well wherein said exposed face is configured to inhibit snagging, said battery cover having a slot being recessed into said exposed surface, said slot having a lower bounding surface, said lower bounding surface being concavely arcuate with respect to said exposed surface of said battery cover wherein said slot is configured to insertably receive a coin for removing said battery cover from said housing;
an annular ring extending through said hole in said housing;
a chain being coupled to said housing, said chain comprising a plurality of links, a respective link of said chain extending through said annular ring;
a clamp being coupled to said chain wherein said clamp is configured to be manipulated by the user, said clamp being urgeable into an open position wherein said clamp is configured to be removably coupled to a support, said clamp being biased into a closed position wherein said clamp is configured to releasably engage the support, said clamp comprising:
a pivot extending through a respective link of said chain, said pivot being distally located with respect to said housing;
a first jaw being rotatably coupled to said pivot, said first jaw being rotatable about a lengthwise axis of said chain wherein said clamp is configured to have said housing rotate on the support to which said clamp is removably coupled, said first jaw having a distal end with respect to said pivot, said first jaw being curved such that said distal end is directed toward said pivot wherein said first jaw is configured to be suspended on the support;
a second jaw being pivotally coupled to said pivot, said second jaw being biased into a first position having said second jaw extending between said pivot and said distal end of said first jaw wherein said second jaw is configured to retain said first jaw on the support, said second jaw being urgeable into a second position having said second jaw being displaced from said distal end of said first jaw wherein said second jaw is configured to have said first jaw be removable from the support; and
a finger extending laterally away from said second jaw wherein said finger is configured to be depressed by the user, said second jaw being urged into said second position when said finger is depressed wherein said finger is configured to have the user release said first jaw from the support.

15. A method of tracking time spent performing a task, the steps of the method comprising:
depressing a button on a housing an initial time, said housing having a front face, said button being positioned on said front face, said housing having a plurality of non-numeric visual indicators being disposed on said front face, said housing having an electronic timer being disposed within said housing, said electronic timer being actuated to countdown a duration of time when said button is depressed said initial time, said duration of time counted down by said electronic timer being adjustable by pre-determined increments of time, a default duration of time being selected when said button is depressed initial time, said duration of time being incrementally increased by said pre-determined increments of time each time said button is depressed subsequent to being depressed said initial time, a number of said plurality of non-numeric visual indicators which corresponds to the number of pre-determined increments of time selected by said button being actuated when said electronic timer is actuated, said number of said plurality of non-numeric visual indicators being sequentially de-actuated when each pre-determined increment of time of said duration of time being counted down elapses, said housing having a speaker being integrated into said housing wherein said speaker is configured to emit an audible alert from said housing, said housing having a vibration unit being integrated into said housing;
depressing said button a number of times subsequent to depressing said button said initial time which corresponds to the number of pre-determined increments of time to be added to said duration of time;
observing said number of said plurality of non-numeric visual indicators which are actuated wherein said number of said plurality of non-numeric visual indicators which are actuated is configured to visually communicate the duration of said duration of time being counted down;
continually observing said number of said plurality of non-numeric visual indicators which are actuated subsequent to said number of said plurality of non-numeric visual indicators being sequentially de-actuated wherein said plurality of non-numeric visual indicators when are actuated is configured to visually communicate the remainder of said duration of time being counted down;
responding to an audible alert emitted by said speaker when said speaker is actuated wherein said speaker is configured to audibly communicate that said duration of time being counted down has elapsed; and
responding to vibration produced in said housing by said vibration unit when said vibration unit is actuated wherein said vibration unit is configured to physically communicate that said duration of time being counted down has elapsed.
